(19) United States
(12) Patent Application Publication
(10) Pub. No.: US 2017/0091177 A1
(43) Pub. Date: Mar. 30, 2017

(54) MACHINE TRANSLATION APPARATUS, MACHINE TRANSLATION METHOD AND COMPUTER PROGRAM PRODUCT

(71) Applicant: Kabushiki Kaisha Toshiba, Tokyo (JP)

(72) Inventors: Satoshi SONOO, Chigasaki Kanagawa (JP); Kazuo SUMITA, Yokohama Kanagawa (JP)

(21) Appl. No.: 15/257,052

(22) Filed: Sep. 6, 2016

(30) Foreign Application Priority Data
Sep. 30, 2015 (JP) 2015-194048

(51) Int. Cl. G06F 17/28; G10L 13/08

(52) U.S. Cl. CPC G06F 17/2836; G10L 13/08; G06F 17/2854

(57) ABSTRACT

According to one embodiment, a machine translation apparatus includes a memory and a hardware processor in electrical communication with the memory. The memory stores instructions. The processor execute the instructions to translate a text in a first language to a plurality of translation results in a second language, output at least one of the plurality of translation results to a screen, and synthesize a speech from at least another one of the plurality of translation results.

### CROSS REFERENCE TO RELATED APPLICATIONS

This application is based upon and claims the benefit of priority from Japanese Patent Application No. 2015-194048, filed Sep. 30, 2015, the entire contents of which are incorporated herein by reference.

### FIELD

Embodiments described herein relate to a machine translation apparatus, a machine translation method, and a computer program product.

### BACKGROUND

Recently, the development of natural language processing that targets spoken language has been progressed. For example, it has been widely used a machine translation technique that translates travel conversations by using portable terminal. Because the travel conversations include short utterances and their contents are relatively simple, translation with high content intelligibility has been achieved.

On the other hand, in utterance manner called “spoken monologue” that one speaker speaks a certain amount of time in a meeting or a lecture presentation and so on, there is a case where utterances are continued as a sentence without interval. In this case, it needs to divide the sentence and perform translation process gradually in order to enhance immediacy of information transmission or in order to avoid translation of a long sentence that is difficult to analyze. This translation is called incremental translation or simultaneous translation.

In the simultaneous translation, there is a technique that performs speech synthesis of translation result text and transmits information by utilizing the synthesized speech in order to achieve natural communication via speech. However, in the case where there is a time difference between an utterance time of speech uttered by a speaker and a reproduction time of synthesized speech of translation result text, simultaneity of communication is lost because the time difference becomes longer as the utterance continues. In other words, in the simultaneous translation, synthesized speech of the original translation result text is hard to listen to as speech and it might interrupt understanding of the translation result.

Moreover, there is a technique that detects a time difference between an utterance time of a speaker and a reproduction time of synthesized speech of translation result text, and performs retranslation by replacing translation of different words having the same meaning, and reduces the time difference by outputting translation result that is appropriate for speech synthesis.

However, in the case where outputting plain and simplified translation result with consideration of reproduction time, there is a problem that accuracy of content transmission becomes lower even though it becomes easy to listen to as speech.

### BRIEF DESCRIPTION OF THE DRAWINGS

FIG. 1 illustrates a functional block diagram of a machine translation apparatus 100 according to the first embodiment.

FIG. 2 illustrates a flow chart of the translation process according to the first embodiment.

FIG. 3 illustrates a construction technique of the post editing model 108 by utilizing a parallel corpus.

FIG. 4 illustrates a construction technique of the post editing model 108 by utilizing results of manual editing.

FIG. 5 illustrates an example result of post editing by the translation editor 107.

FIG. 6 illustrates examples of input sentences, translated sentences and evaluation data that are utilized for evaluation model training.

FIG. 7 illustrates an example for calculation of evaluation values by the evaluator 103.

FIG. 8 illustrates a figure for explaining a user interface of machine translation process according to the first embodiment.

FIG. 9 illustrates a figure for explaining another user interface of machine translation process according to the first embodiment.

FIG. 10 illustrates a machine translation apparatus 100 according to the second embodiment in the case where speech in input.

FIG. 11 illustrates a flow chart of the machine translation process in the second embodiment in the case where speech in input.

FIG. 12 illustrates a functional block diagram of a machine translation apparatus 100 according to the third embodiment in the case where user inputs a condition.

FIG. 13 illustrates an example for designating conditions for speech synthesis and display in the condition designator 1201.

### DETAILED DESCRIPTION

Hereinafter, embodiments of the present invention are described with reference to the drawings.

Certain embodiments described herein are described with respect to a translation example in which a first language corresponding to an original language is set to Japanese and a second language corresponding to a target language is set to English. However, the combination of translation languages is not limited to this case and the embodiments can be applied to combinations of any languages.

### First Embodiment

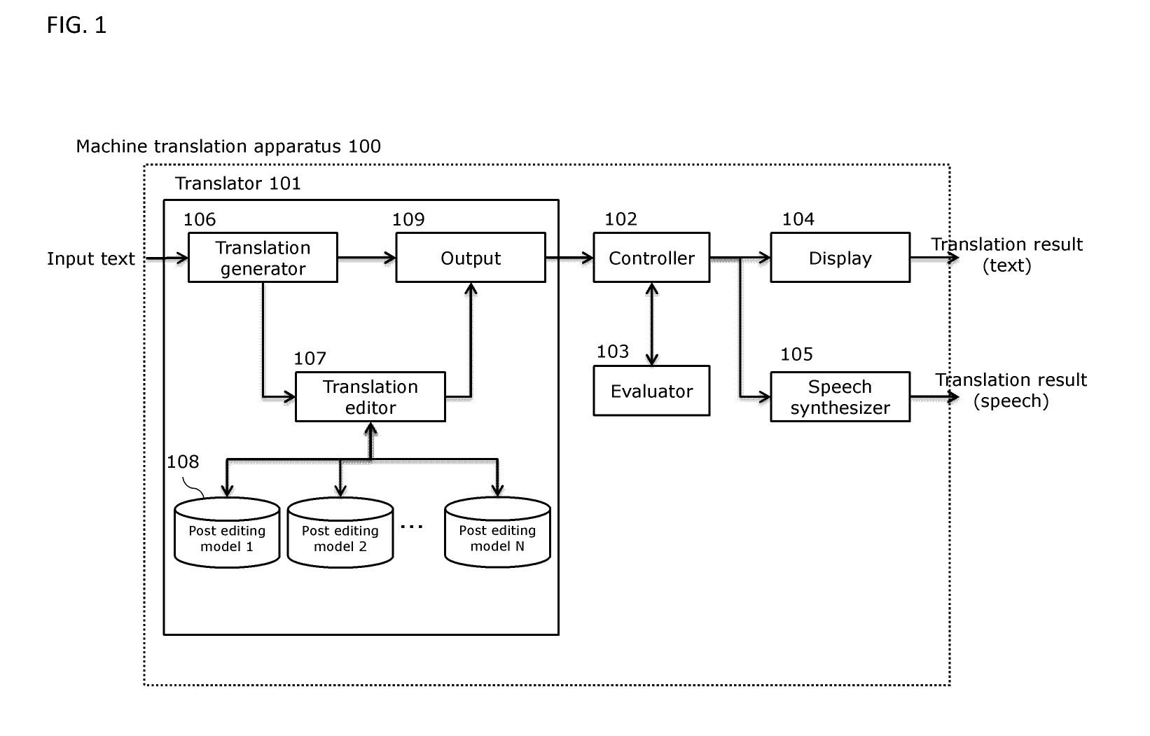

FIG. 1 illustrates a functional block diagram of a machine translation apparatus 100 according to the first embodiment. As illustrated in FIG. 1, the machine translation apparatus 100 includes a translator 101, a controller 102, an evaluator 103, a display 104 and a speech synthesizer 105. Moreover, the translator 101 includes a translation generator 106, a translation editor 107, a post editing model 108 and an output 109.

The translator 101 receives an input text of the first language that is an input to the machine translation apparatus 100, and outputs at least equal to or more than two translation results of the second language. The input text of the first language may be inputted directory by such as a keyboard (not illustrated), and may be a recognition result by a speech recognition apparatus (not illustrated).

The translation generator 106 receives the input text of the first language and generates a translation result (translation text) of the second language by machine translation. As for the machine translation, it can apply conventional rule-based machine translation, example-based machine translation, statistical machine translation, and so on.

The translation editor 107 receives the translation result from the translation generator 106 and generates a new translation result by post-editing a part of the machine translation result by utilizing the post editing model 108 that includes editing rule sets of the second language. Moreover, the translation editor 107 may utilize different kinds of post editing models, and generates one translation result with post editing for one post editing model. As for the post editing models and the post editing process, the translation editor 106 can apply statistical post editing that performs statistical translation by utilizing, for example, the original language as machine-translated sentence and the target language as reference translation.

The output 109 receives the translation result generated by the translation generator 106 and the translation result generated by the translation editor 107, and outputs the translation results to the controller 102.

The controller 102 receives the translation results from the translator 101 and acquires evaluation values corresponding to the translation results from the evaluator 103. The controller 102 outputs the translation results to the display 104 and the speech synthesizer 105 based on the acquired evaluation values.

The evaluator 103 acquires the translation results via the controller 102, and calculates the evaluation values corresponding to the translation results. For example, as an evaluation index, the evaluation value can utilize adequacy that represents how much accurate the content of the input sentence is translated into the translated sentence in the translation result or fluency that represents how much natural the translated sentence of the translation result is in the second language. Moreover, the evaluation value can utilize combinations of a plurality of evaluation indexes. These indexes may be judged by a bilingual evaluator or may be estimated by an estimator constructed by machine translation based on judgment results of a bilingual evaluator.

The display 104 receives the translation result from the controller 102 and displays the translation result on a screen as character information. The screen in the present embodiment may be any screen device such as a screen of a computer, a screen of a smartphone and a screen of a tablet.

The speech synthesizer 105 receives the translation result from the controller 102, and performs speech synthesis of text of the translation result, and outputs the synthesized speech as speech information. The speech synthesis process can be conventional concatenation synthesis, formant synthesis, Hidden Markov Model-based synthesis, and so on. These speech synthesis techniques are widely known, therefore, the detailed explanations are omitted. The speech synthesizer reproduces the synthesized speech from a speaker (not illustrated). The machine translation apparatus 100 may include the speaker for reproducing the synthesized speech.

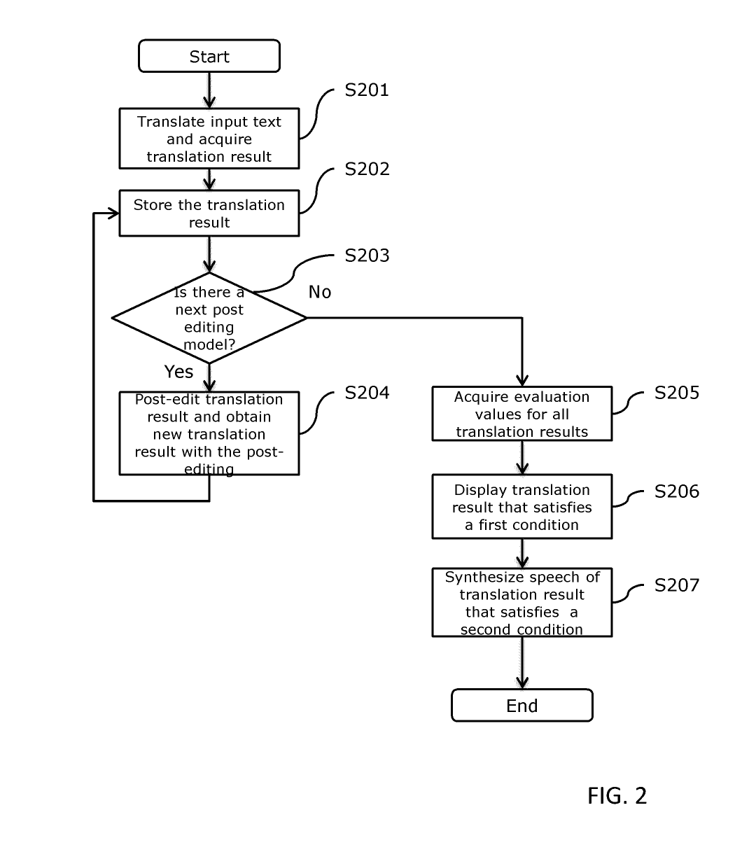

Next, the translation process of the machine translation apparatus 100 according to the first embodiment is explained. FIG. 2 illustrates a flow chart of the translation process according to the first embodiment.

First, the translation generator 106 receives an input text and generates a translation result (step S201).

Next, the output 109 stores the translation result (step S202).

Next, the translation editor 107 detects the post editing model 108. If the post editing model 108 is available (Yes in steps S203), the translation editor 107 generates a new translation result by applying post-editing to the translation result generated by the translation generator 106, and backs to step S202 (step S204).

After finishing post editing with all post editing models (No in step S203), the evaluator 103 calculates evaluation results for all translation results (step S205).

Next, the controller 102 performs judgment of a first condition for displaying on the screen and outputs one of translation results that satisfy the first condition to the display 104. The display 104 displays the translation result on the screen (steps S206).

Finally, the controller 102 performs judgment of a second condition for speech synthesis and outputs one of translation results that satisfy the second condition to the speech synthesizer 105. The speech synthesizer performs speech synthesis of the translation result (step S207) and it finishes processing.

Next, a particular example of machine translation process according to the present embodiment is explained.

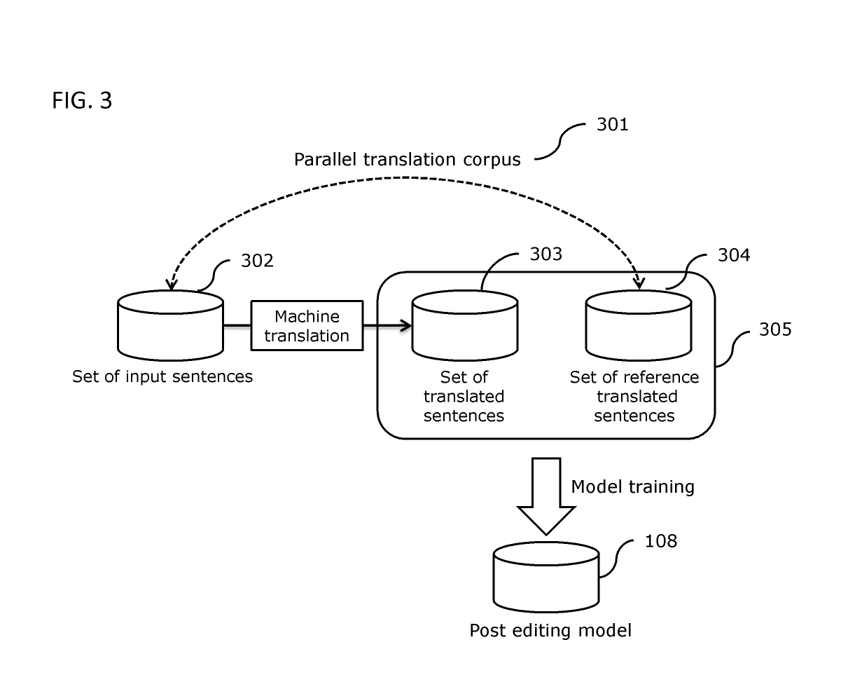

FIG. 3 illustrates a construction technique of the post editing model 108. First, by utilizing a parallel translation corpus 301 that has correspondences between input sentences and reference translated sentences, it translates all or a part of a set of input sentences 302 and generates a set of translated sentences 303. By taking correspondences between the set of translated sentences 303 and a set of reference translated sentences 304, it can obtains a parallel set 305. By applying a conventional technique of statistical translation (for example, training step of statistical translation based on phrase) to the obtained parallel set 305, it can construct the post editing model 108.

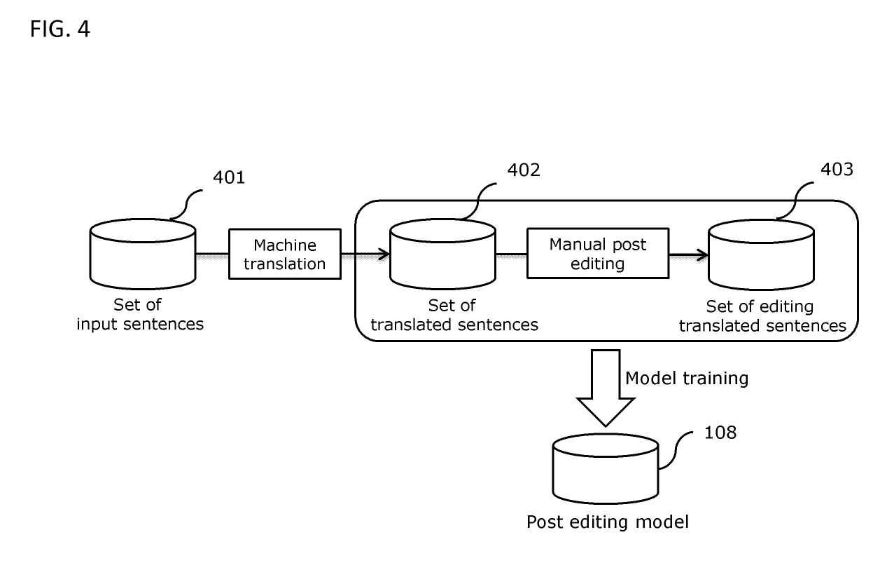

Moreover, FIG. 4 illustrates another construction technique of the post editing model 108. First, it machine-translates a set of input sentences 401 (it does not need to be a parallel corpus) and obtains a set of translated sentences 402. A post editor edits the set of translated sentences manually and it obtains a set of editing translated sentences 403. By utilizing the set of translated sentences 402 and the set of editing translated sentence 403, as described above, it can construct the post editing model 108 by statistical translation technique. Although this technique needs work by the post editor, there are advantages that it makes it possible to control the details of post editing and it does not need a parallel corpus.

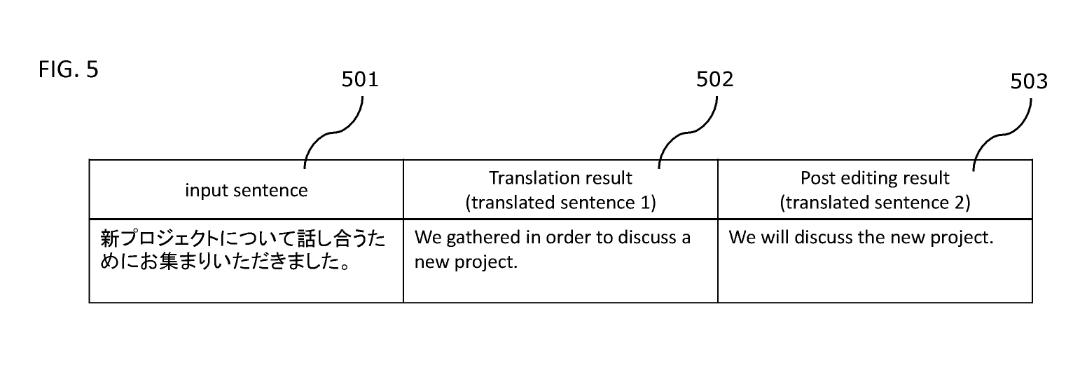

FIG. 5 illustrates an operation of the translation editor 107. The example in FIG. 5 assumes that the translation result generated by the translation generator 106 for an input sentence 501 [ [symbol] [symbol] [symbol] [symbol] [symbol] [symbol] ] is a translated sentence 502 [We gathered in order to discuss a new project.]. For the translated sentence 502, the translation editor 107 applies the post editing model 108 and obtains a translated sentence 503 [We will discuss the new project.] that is a result of post editing by replacing a phrase (partial character string) corresponding to [gathered in order to] with another character [will] and by replacing [a] with [the]. This action by the translation editor 107 corresponds to a statistical translation from the translation result (English) of the second language to the second language (English), and it can be achieved by applying a conventional technique of statistical translation (for example, decoding process of statistical translation based on phrase).

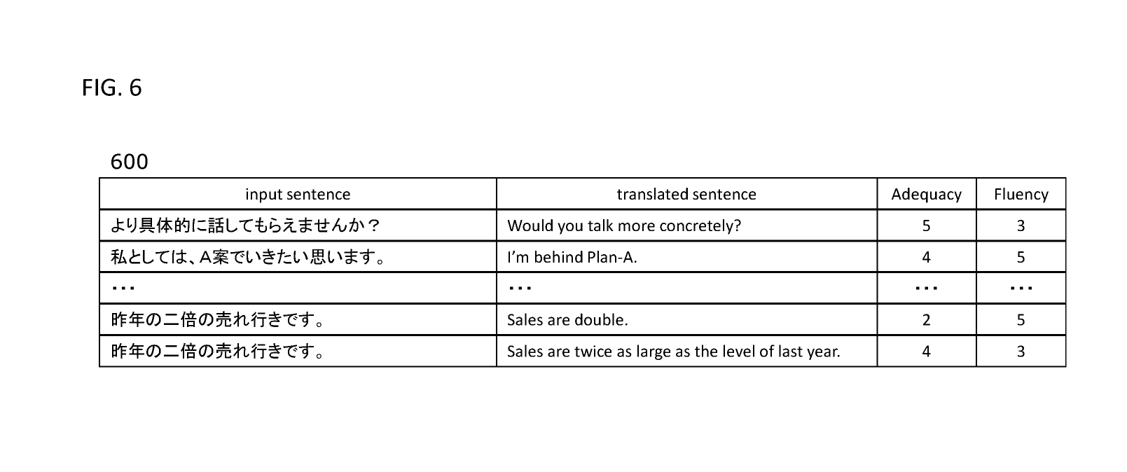

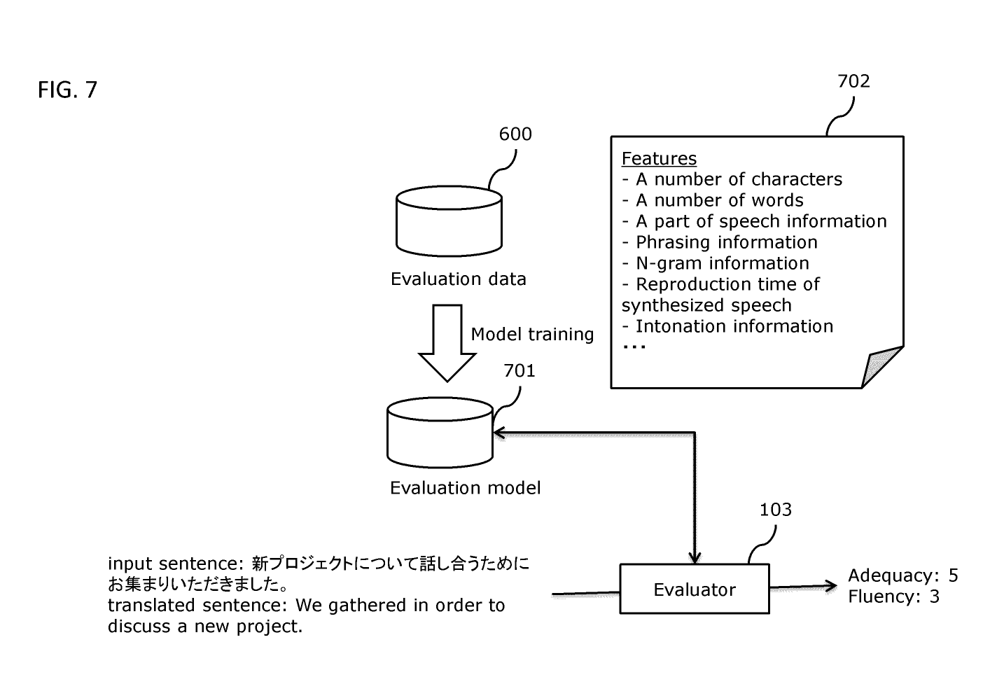

FIG. 6 and FIG. 7 illustrate an operation of the evaluator 103. FIG. 6 illustrates an evaluation data 600 that evaluates adequacy and fluency by five grades evaluation (5 is the highest grade and 1 is the lowest grade) for a plurality of input sentences and translated sentences. FIG. 7 illustrates one example for calculating evaluation values for a translation result. First, it constructs an evaluation model 701 that inputs input sentences and translated sentences from the evaluation data 600 and outputs evaluation values. For model training, for example, it can utilize widely known machine learning techniques such as Multi-class Support Vector Machine (Multi-class SVM). As features 702 for model training, it can utilize a number of characters of input sentence and translated sentence, a number of words of input sentence and translated sentence, a part of speech information of input sentence and translated sentence, phrasing information of input sentence and translated sentence, N-gram information of input sentence and translated sentence, a reproduction time of synthesized speech and intonation information of speech-synthesized translated sentence and so on. By referring the evaluation model 701, the evaluator 103 calculates evaluation values for any translation result. The example in FIG. 7 indicates that evaluation values of adequacy 5 and fluency 3 are calculated for the input sentence [ [symbol] [symbol] [symbol] [symbol] [symbol] [symbol] ] and the translated sentence [We gathered in order to discuss a new project.].

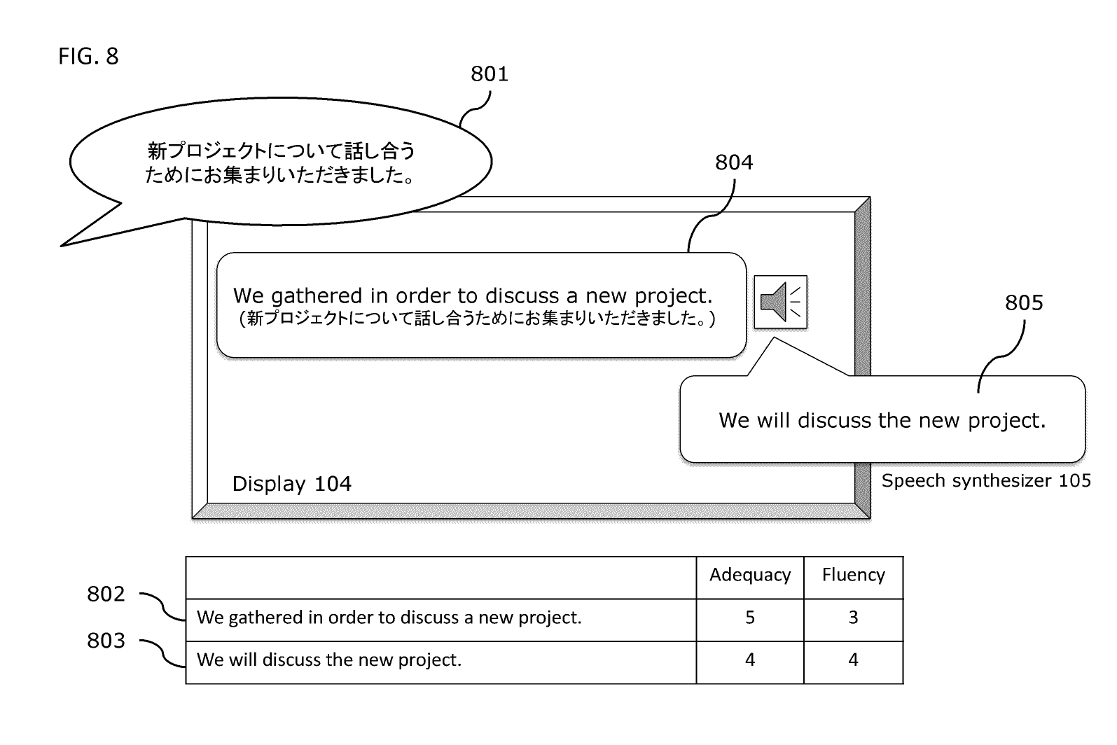

FIG. 8 illustrates a user interface of the machine translation process according to the present embodiment. It obtains the translated sentence 802 and the translated sentence 803 for the input text 801 [ [symbol] [symbol] [symbol] [symbol] [symbol] ] by driving the translator 101. Moreover, by driving the evaluator 103, it obtains adequacy 5 and fluency 3 that are evaluation values of the translated sentence 802 and adequacy 4 and fluency 4 that are evaluation values for the translated sentence 803. The controller 102 selects the translated sentence 802 that has the highest evaluation value for adequacy among a plurality of translated sentences, and displays it in a display area 804 via the display 104. And, the controller 102 selects the translated sentence 803 that has the highest evaluation value for fluency other than the translated sentence 802, and outputs it in a form of synthesized speech 805 via the speech synthesizer with synchronization. In this way, for the input text 801, it can output a translation result that is more fluent and easy to listen to as speech information and a translation result that is more accurate as character information. Moreover, the synthesized speech may be output automatically in response to the translation result, and it may switch whether the synthesized speech is output or not in response to manipulation by user.

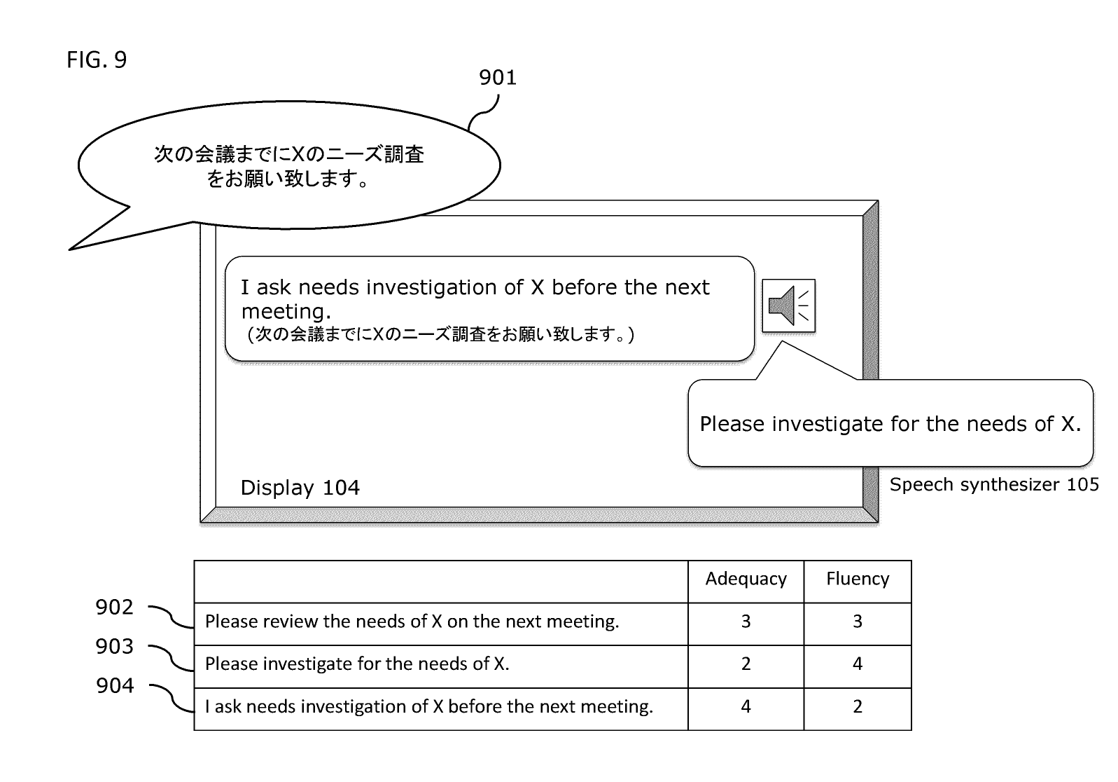

FIG. 9 illustrates another user interface of machine translation process according to the present embodiment. It obtains a plurality of translation results and evaluation scores 902, 903, 904 for the input text 901 [ [symbol] [symbol] [symbol] [symbol] ]. Although the summation of the evaluation values is the same value 6 for all cases, it can understand content outline by outputting the translation result 903 that is the most fluent as speech, and it can communicate content of original utterance accurately by displaying the translation result 904 that is the most accurate as text. In this way, it can support content understanding in a complementary way by speech information and text information.

### Second Embodiment

Next, a machine translation apparatus according to a second embodiment is explained.

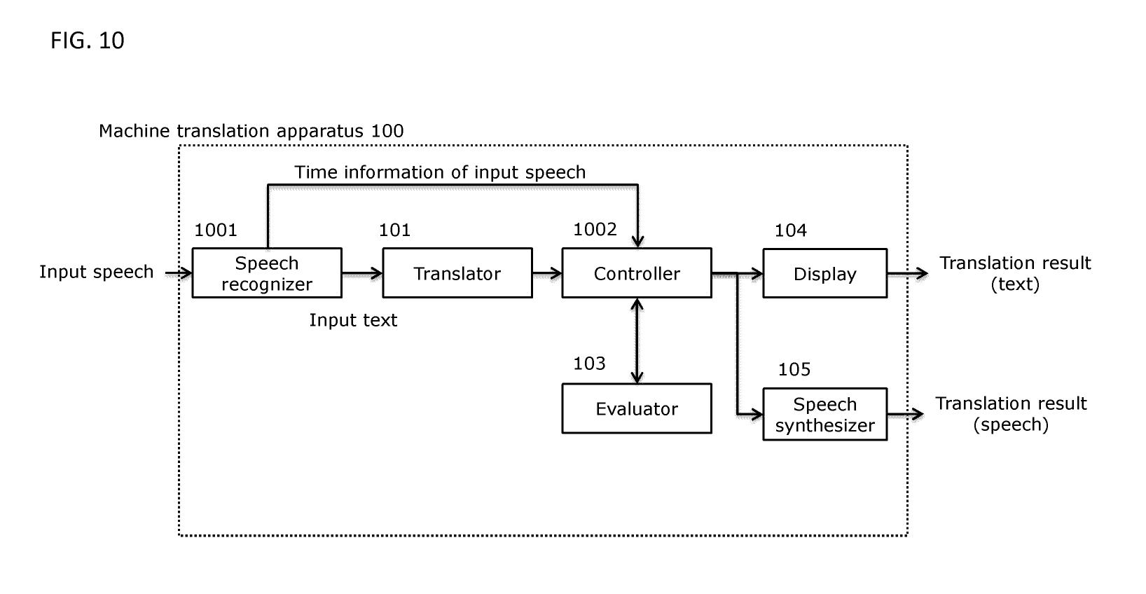

FIG. 10 illustrates a functional block diagram of a machine translation apparatus 100 in the case where speech in input. The machine translation apparatus 100 further includes a speech recognizer 1001 that receives input speech and outputs input text as recognition result and time information (for example, start time and end time of speech) of the input speech. In other words, the speech recognizer 100 outputs the input text to the translator 101 described in FIG. 1 and the time information to the controller 1002.

The controller 1002 receives a plurality of translation results from the translator 101 described in FIG. 1 and receives the time information of the input speech from the speech recognizer 1001. Moreover, the controller 1002 outputs translation results to the display 104 and the speech synthesizer 105 based on evaluation values and the time information.

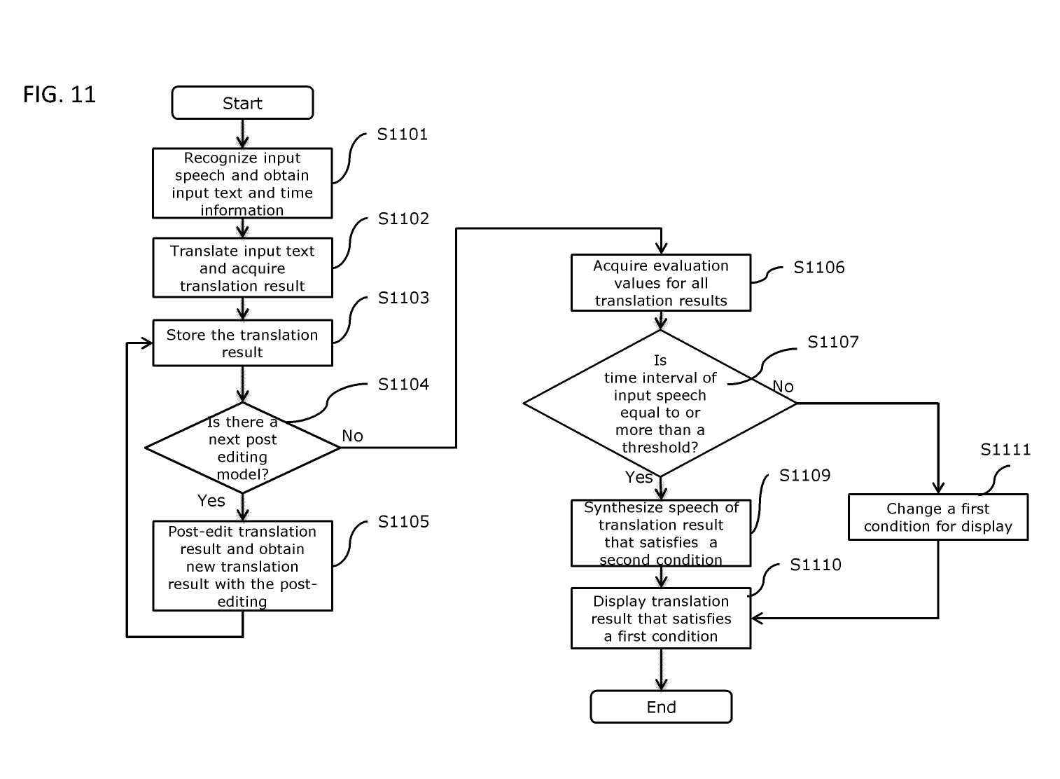

It explains a machine translation process by the machine translation apparatus 100 according to the second embodiment. FIG. 11 illustrates a flow chart of the machine translation process in the second embodiment.

First, the speech recognizer 1001 receives the input speech and generates the input text that is a recognition result of the input speech and the time information (step S1101).

Next, the translation generator 106 in the translator 101 (refer FIG. 1 for details) receives the input text and generates the translation result (step S1102). Next the output 109 stores the recognition result (step S1103).

Next, the translation editor 107 detects the post editing model 108. If the post editing model 108 is available (Yes in steps S1104), the translation editor 107 generates a new translation result by applying post-editing to the translation result generated by the translation generator 106, and backs to step S1103 (step S1105).

After finishing post editing with all post editing models (No in step S1105), the evaluator 103 calculates evaluation results for all translation results (step S1106).

Next, the controller 1002 calculates a time difference (time interval) from the last input speech by using the time information. If the time difference is equal to or more than a threshold (Yes in step S1107), it performs a judgment based on a second condition for speech synthesis and outputs one of the translation results that satisfy the second condition to the speech synthesizer 105. The speech synthesizer 105 synthesizes speech of the translation result (step S1109). For example, the second condition for speech synthesis is such as whether evaluation value for fluency is the maximum.

Next, the controller 1002 performs a judgment based on a first condition for display on the screen and outputs one of the translation results than satisfy the first condition to the display 104. The display 104 displays the translation result on the screen (step S1110) and it finishes the process. For example, the first condition for display on the screen is whether evaluation value for adequacy is the maximum.

Moreover, if the time difference is lower than the threshold (No in step S1107), it changes the first condition for display on the screen without performing speech synthesis (step S1111). For example, it changes the first condition to a condition that the summation of evaluation values for adequacy and fluency is the maximum. Finally, it performs the step S1110 and finishes the process.

According to the second embodiment, it can avoid a situation where time interval of input utterances is short and the next utterance is input before finishing the reproduction of synthesized speech. Moreover, it can keep simultaneity of communication by displaying the translation result on the screen.

### Third Embodiment

Next, a machine translation apparatus according to a third embodiment is explained.

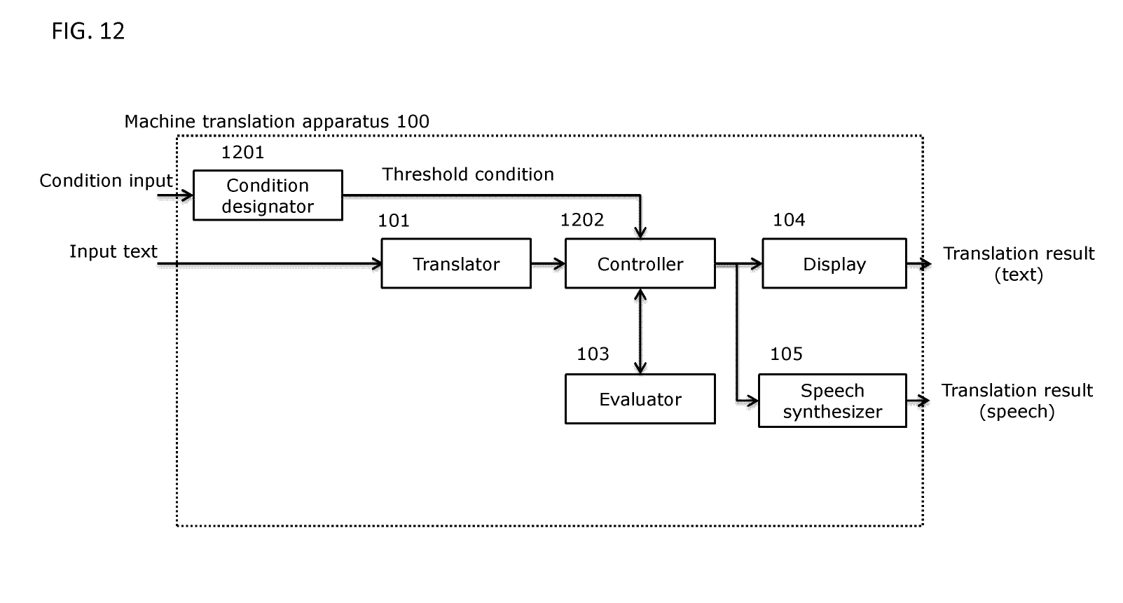

FIG. 12 illustrates a functional block diagram of a machine translation apparatus 100 that drives the controller 1202 in response to a condition input from a user. The machine translation apparatus 100 further includes a condition designator 1201 that receives a condition input from a user and determines conditions for display on the screen and speech synthesis.

Moreover, the controller 1202 receives a plurality of translation results from the translator 101 described in FIG. 1 and receives a designated condition from the condition designator 1201. Then, the controller 1202 selects translation results of which evaluation values satisfy the condition designated by the condition designator 1201, and outputs the translation results to the display 104 and the speech synthesizer 105.

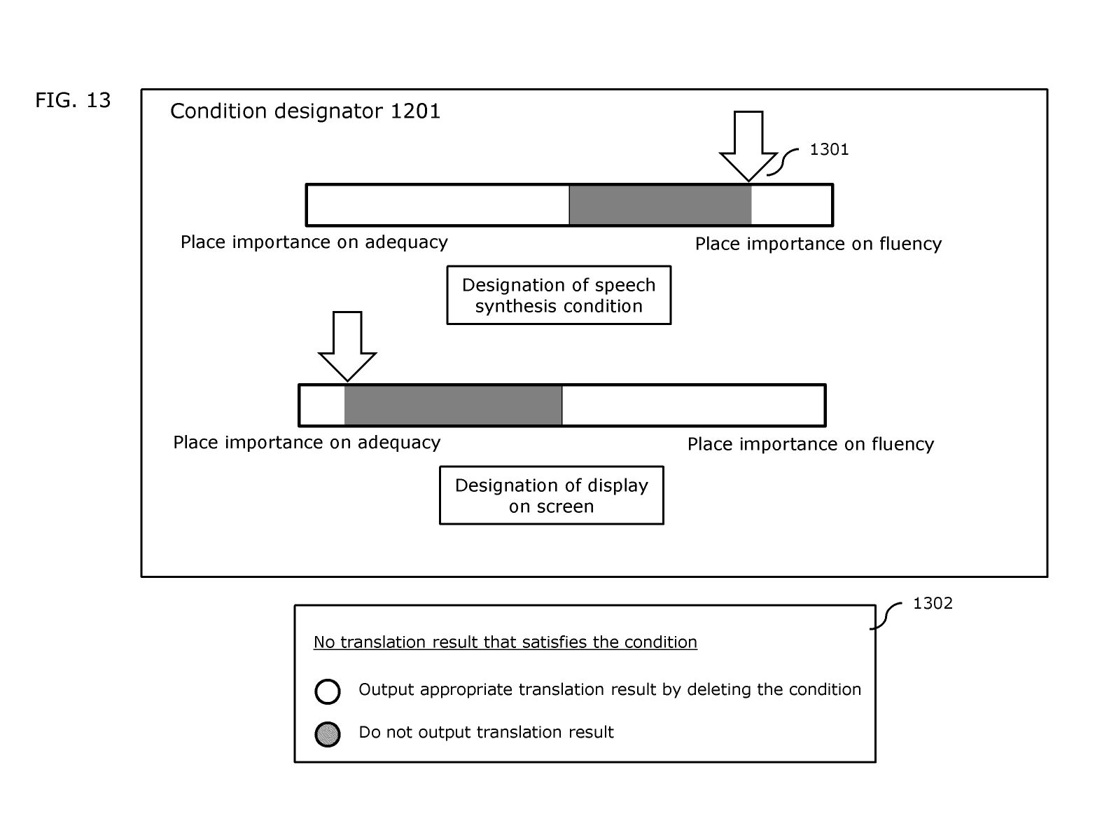

FIG. 13 illustrates one example of condition input by user in the condition designator 1201. By using slide bars, it designates thresholds for evaluation values when selecting translation results for speech synthesis and display. For example, in the case where a designated value for the first condition for display is 4 in the 5-grade evaluation that is placing importance on adequacy and a designated value 1301 for the second condition for speech synthesis is 3 in the 5-grade evaluation that is placing importance on fluency, the controller 102 selects a translation result of which evaluation value for adequacy is equal to or more than 4 for display output and displays the translation result on the screen, and selects a translation result of which evaluation value for fluency is equal to or more than 3 for speech output and outputs the translation result to the speech synthesizer. If there are more than one translation results that satisfy the condition, the controller selects one of them (for example, the translation result of which summation value of adequacy and fluency is the maximum) and outputs to the speech synthesizer. Moreover, if there is no translation result that satisfies the first condition or the second condition, it may output another translation result on the screen with the notification of the situation to user, or it may ask user to select whether it outputs the translation result or not.

The instructions specified in the process flows in the above embodiments can be executed utilizing software programs. The general computer system can store the programs in advance, and by reading the programs, it can achieve the same effect as the machine translation apparatus according to the above embodiments.

The instructions described in the above embodiments may be stored in magnetic disk (such as flexible disk and hard disk), optical disk (such as CD-ROM, CD-R, CD-RW, DVD-ROM, DVD±R, DVD±RW), semiconductor memory or storage device similar to them. It may use any recoding formats as long as a computer or an embedded system can read a storage medium. The computer reads the programs from the storage medium and executes instructions written in the programs by using CPU, and it can achieve the same operations as the machine translation apparatus according to the above embodiments. Moreover, it can obtain and read the programs to be executed via network when the computer obtains or reads the programs.

Moreover, a part of each process for achieving the above embodiments can be executed by OS (Operating System) that works on the computer or embedded system based on instructions of programs installed on the computer or the embedded system from a storage medium, data based management software or MW (Middle Ware) such as network.

Moreover, the storage medium in the above embodiments includes not only a medium independent from the computer or the embedded system but also a storage medium that downloads and stores (or temporary stores) programs transmitted via LAN, internet and so on.

Moreover, the number of the storage media is not limited to one. The storage medium in the above embodiments includes a case where the processes of the above embodiments are executed from more than one storage media, and the configuration of the storage medium can be any configuration.

Moreover, the computer in the above embodiments is not limited to a personal computer, and it may be an arithmetic processing device included in an information processing apparatus or a microprocessor. The computer is a collective term of devices and apparatuses that can achieve functions according to the above embodiments by programs.

The functions of the translator 101, the controller 102, the evaluator 103, the speech synthesizer 105, the speech recognizer 1001, the controller 1002, the condition designator 1201 and the controller 1202 in the above embodiments may be implemented by a processor coupled with a memory. For example, the memory may stores instructions for executing the functions and the processor may read the instructions from the memory and execute the instructions.

The terms used in each embodiment should be interpreted broadly. For example, the term “processor” may encompass but not limited to a general purpose processor, a central processing unit (CPU), a microprocessor, a digital signal processor (DSP), a controller, a microcontroller, a state machine, and so on. According to circumstances, a “processor” may refer but not limited to an application specific integrated circuit (ASIC), a field programmable gate array (FPGA), and a programmable logic device (PLD), etc. The term “processor” may refer but not limited to a combination of processing devices such as a plurality of microprocessors, a combination of a DSP and a microprocessor, one or more microprocessors in conjunction with a DSP core.

As another example, the term “memory” may encompass any electronic component which can store electronic information. The “memory” may refer but not limited to various types of media such as random access memory (RAM), read-only memory (ROM), programmable read-only memory (PROM), erasable programmable read only memory (EPROM), electrically erasable PROM (EEPROM), non-volatile random access memory (NVRAM), flash memory, magnetic or optical data storage, which are readable by a processor. It can be said that the memory electronically communicates with a processor if the processor read and/or write information for the memory. The memory may be integrated to a processor and also in this case, it can be said that the memory electronically communicates with the processor.

The term “circuitry” may refer to not only electric circuits or a system of circuits used in a device but also a single electric circuit or a part of the single electric circuit. The term “circuitry” may refer one or more electric circuits disposed on a single chip, or may refer one or more electric circuits disposed on more than one chip or device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, it may combine any components among different embodiments.

What is claimed is:

1. A machine translation apparatus comprising:
a memory that stores instructions; and
a hardware processor in electrical communication with the memory and configured to execute the instructions to:
translate a text in a first language to a plurality of translation results in a second language,
output at least one of the plurality of translation results to a screen, and
synthesize a speech from at least another one of the plurality of translation results.

2. The apparatus according to claim 1, wherein the hardware processor is further configured to synchronize the output to the screen with an output of the speech.

3. The apparatus according to claim 1, wherein the hardware processor is further configured to calculate evaluation values for each one of the plurality of translation results based at least in part on a plurality of evaluation criteria.

4. The apparatus according to claim 3, wherein the plurality of evaluation criteria comprise adequacy for translation from the first language to the second language or fluency as the second language.

5. The apparatus according to claim 3, wherein the hardware processor is further configured to:
receive an instruction from a user, and
determine thresholds for the evaluation values based at least in part on the instruction from the user.

6. The apparatus according to claim 1, wherein the hardware processor is further configured to select at least a first and a second translation result among the plurality of translation results and output the first translation result to the screen and synthesize the speech from the second translation result.

7. The apparatus according to claim 6, wherein the first translation result is a translation result that has a highest evaluation value for translation adequacy and the second translation result is a translation result that has a highest evaluation value for fluency of the second language.

8. The apparatus according to claim 1, further comprising a storage that stores one or more post editing models, each of the post editing models constructed by a rule set for editing at least a part of a translation result to another character,
wherein the hardware processor is further configured to:
translate the text to a first translation result in the second language, and
edit the first translation result to a second translation result by at least utilizing the one or more post editing models,
wherein the plurality of translation results include the first translation result and the second translation result.

9. The apparatus according to claim 1, wherein the hardware processor is further configured to:
recognize a second speech in the first language included in the text,
generate time information of the second speech, and
control an output of the speech based on the time information.

10. The apparatus according to claim 1, further comprising:
the screen; and
a speaker configured to reproduce the speech.

11. A machine translation method, the method comprising:
translating, by a computer system comprising one or more hardware processors, a text in a first language to a plurality of translation results in a second language,
outputting, by the computer system, at least one of the plurality of translation results to a screen; and
synthesizing, by the computer system, a speech from at least another one of the plurality of translation results.

12. The method according to claim 11, further comprising;
synchronizing the output to the screen with an output of the speech.

13. The method according to claim 11, further comprising;
calculating evaluation values for each one of the plurality of translation results based at least in part on a plurality of evaluation criteria.

14. The apparatus according to claim 13, wherein the evaluation criteria comprise adequacy for translation from the first language to the second language or fluency as the second language.

15. The apparatus according to claim 11, further comprising;
selecting at least a first and a second translation result among the plurality of translation results,
outputting the first translation result to the screen, and
synthesizing the speech from the second translation result.

16. The apparatus according to claim 15, wherein the first translation result is a translation result that has a highest evaluation value for translation adequacy and the second translation result is a translation result that has a highest evaluation value for fluency of the second language.

17. The apparatus according to claim 11, further comprising;
translating the text to a first translation result in the second language, and
editing the first translation result to a second translation result by utilizing one or more post editing models, each of the post editing models constructed by a rule set for editing at least a part of a translation result to another character,
wherein the plurality of translation results include the first translation result and the second translation result.

18. The apparatus according to claim 11, further comprising;
recognizing a second speech in the first language included in the text,
generating time information of the second speech, and
controlling an output of the speech based on the time information.

19. The apparatus according to claim 13, further comprising;
receiving an instruction from a user, and
determining thresholds for the evaluation values based at least om part on the instruction from the user.

20. A computer program product comprising a non-transitory computer readable medium including programmed instructions for machine translation, wherein the instructions, when executed by a computer, cause the computer to perform:
translating a text in a first language to a plurality of translation results in a second language,
outputting at least one of the plurality of translation results to a screen; and
synthesizing a speech from at least another one of the plurality of translation results.
